(19) United States
(12) Patent Application Publication
(10) Pub. No.: US 2005/0239923 A1
(43) Pub. Date: Oct. 27, 2005

(54) Water-soluble paint composition and paint

(76) Inventor: Bar-Long Denq, Taipei City (TW)

Correspondence Address: J C PATENTS, INC., 4 VENTURE, SUITE 250, IRVINE, CA, 92618, US

(21) Appl. No.: 10/871,155

(22) Filed: Jun. 18, 2004

(30) Foreign Application Priority Data
Apr. 21, 2004 (TW) 93111049

(51) Int. Cl. C08L 63/00; C08L 75/00

(52) U.S. Cl. 523/402; 525/452; 525/523

(57) ABSTRACT

A water-soluble paint composition comprising an emulsified paint (A) dispersed in an aqueous medium (B) is provided. The emulsified paint (A) comprises a multifunctional-group monomer at least comprising two or more functional-groups, wherein the multifunctional-group monomer initiates cross-linking during dehydration (baking) process to form a semi-interpenetrating polymer network structure or a interpenetrating polymer network structure. Application of the water-soluble paint composition on the outer surface of an electrical product is capable of improving its mechanical properties such as hardness, abrasion resistance and solvent resistance.

### BACKGROUND OF THE INVENTION

1. Field of the Invention

The present invention generally relates to a water-soluble paint composition and a paint. More particularly, the present invention relates to a water-soluble paint composition and a paint applicable to various electronic products such as notebook, cell phone, personal digital assistant (PDA) and the like.

2. Description of Related Art

The water-soluble paint is free of volatile solvent and widely used for applying on interior and exterior surfaces of buildings and the like. Currently, several articles or electronic products are considering toward the trend of “green environmental protection”. Not only materials for fabricating the articles or electronic products are required to meet the green environmental protection requirement but also the paints applied on the outer surfaces of these articles or electronic products.

Usually, water-soluble emulsified acrylic paints are utilized on several household appliances. However, for an electronic product such as notebook, cell phone, personal digital assistant (PDA) or the likes, the mechanical properties such as hardness, abrasion resistance and solvent resistance of its outer surface are need to be considered.

Conventionally, a water-soluble paint is obtained from emulsifying or non-emulsifying styrene monomer, methyl methacrylate monomer or the like. This emulsified paint is composed of difunctional-group monomer so that a linear polymer is formed after dehydration process. If this emulsified paint is applied on the outer surface of the electronic product, the mechanical properties (such as hardness, abrasion resistance and solvent resistance) do not meet the requirements. Hence, the current emulsified paint cannot be applied on the electronic product.

### SUMMARY OF THE INVENTION

Accordingly, the present invention is directed to a water-soluble paint composition and a paint having good mechanical properties after dehydration.

The present invention provides a water-soluble paint composition and a paint applicable to various electronic products such as notebook, cell phone, personal digital assistant (PDA) and the like.

According to an embodiment of the present invention, a water-soluble paint composition is provided. The water-soluble paint composition comprises an emulsified paint (A) dispersed in an aqueous medium (B). The emulsified paint (A) includes a multifunctional-group monomer at least comprising two or more functional-groups, wherein the multifunctional-group monomer readily cross-link during dehydration (baking) process.

According to another embodiment of the present invention, the emulsified paint (A) comprises a water-soluble emulsified polyurethane paint (A1) or an emulsified epoxy resin paint (A2).

The water-soluble emulsified polyurethane paint (A1) comprises a monomer selected from a group consisting of a polyalcohol monomer (a) and a isocyanate monomer (b). The polyalcohol monomer (a) has a formula (1) and the isocyanate monomer (b) has a formula (2) as follows:
R₁—(OH)ₙ (1)
R₂—(NCO)ₘ (2)

In formula (1), R₁ is a carbon chain constituted from primary, secondary, tertiary or quaternary carbons, n is an integer selected from a range 2 to 4, —OH group is bonded to any one of the carbons, and oxygen atom or other atom may be bonded between the carbons.

In formula (2), R₂ is a carbon chain constituted from primary, secondary, tertiary or quaternary carbons, m is an integer selected from a range 2 to 4, —NCO group is bonded to any one of the carbons, and oxygen atom or other atom may be bonded between the carbons.

Each polyalcohol monomer (a) at least includes two or more —OH groups. Preferably, the polyalcohol monomer (a) includes 2 to 12 carbons. The polyalcohol monomer (a) may comprise a single polyalcohol monomer or a mixture of two or more polyalcohol monomers.

Each isocyanate monomer (b) at least includes two or more —NCO groups. Preferably, the isocyanate monomer (b) includes 2 to 12 carbons.

The emulsified epoxy resin paint (A2) at least comprises a monomer selected from a group consisting of an epoxy monomer (c), a polybasic carboxylic acid monomer (d) and an amino group-containing monomer (e). The epoxy monomer (c) has a formula (3), the polybasic carboxylic acid monomer (d) has a formula (4) and the amino group-containing monomer (e) has a formula (5) as follows: 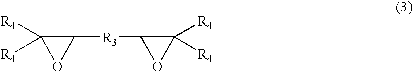
R₅ [symbol] COOH)_{q} (4)

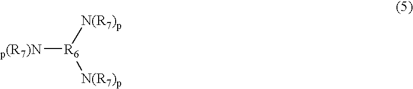

In formula (3), R₃ is a carbon chain constituted from primary, secondary, tertiary or quaternary carbons, and a hetero-atom such as oxygen, nitrogen, silicon, sulfur and the like may be bonded between the carbons. R₄ is hydrogen or alkyl. R₄ may be the same or different, and a hetero-atom such as oxygen, nitrogen, silicon, sulfur and the likes may also be bonded between carbons of R₄.

In formula (4), R₅ is a carbon chain constituted from primary, secondary, tertiary or quaternary carbons, q is an integer selected from a range 2 to 4, each —COOH group is bonded to any one of the carbons, and a hetero-atom such as oxygen, nitrogen, silicon, sulfur and the like may be bonded between the carbons.

In formula (5), R₆ is a carbon chain constituted from primary, secondary, tertiary or quaternary carbons, —N(R₇)ₚ group is bonded to any one of the carbons, and a hetero-atom such as oxygen, nitrogen, silicon, sulfur and the like may be bonded between the carbons. Each R₇ is hydrogen or alkyl, R₇ bonded to nitrogen atom may be the same or different, and p is an integer selected from a range 1 to 2.

Each epoxy monomer (c) at least includes two epoxy groups having a formula (6). The epoxy monomer (c) may comprise a single epoxy monomer or a mixture of two or more epoxy monomers.

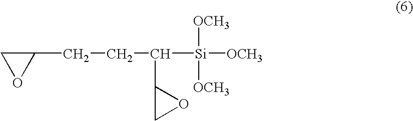

Each polybasic carboxylic acid monomer (d) at least includes two or more —COOH groups. Preferably, the polybasic carboxylic acid monomer (d) includes 2 to 12 carbons.

Each amino group-containing monomer (e) at least includes two or more amino groups. Preferably, the amino group-containing monomer (e) includes 2 to 12 carbons.

The present invention may also be applied to an emulsified polymer paint having a core shell structure. The shell layer of the emulsified polymer paint is first processed to include multi-functional group so that the multifunctional-group initiates cross-linking during the dehydration (baking) process to form a highly cross-linked structure on the shell layer.

The present invention provides a paint comprising powders obtained from drying the said water-soluble paint composition. The powders may be sprayed over a substrate.

In the water-soluble paint composition of the present invention, the hydrophilic difunctional-group monomer or multifunctional-group monomer is bonded on the surface of the emulsified paint. A polymerization is conducted when dehydration (baking) to form a paint having semi-interpenetrating polymer network, interpenetrating polymer network or highly cross-linked structure. Thus, application of the paint of the present invention on the outer surface of the electronic product could improve its mechanical properties (such as hardness, abrasion resistance, solvent resistance and the like).

Comparing with conventional hydrophobic paint, the water-soluble paint composition of the present invention does not harmful to health. Furthermore, powders obtained from drying the water-soluble paint composition may be sprayed over a substrate to improve its mechanical properties.

Both the foregoing general description and the following detailed description are exemplary and explanatory only and are not restrictive of the invention, as claimed. It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a diagram showing a semi-interpenetrating polymer network (SIPN) according to an embodiment of the present invention.

FIG. 2 is a diagram showing an interpenetrating polymer network (IPN) according to an embodiment of the present invention.

FIG. 3 is a diagram showing a typical core shell emulsified polymer according to an embodiment of the present invention.

FIG. 4 is a diagram showing an action between multifunctional-groups of a core shell emulsified polymer according to an embodiment of the present invention.

### DESCRIPTION OF THE EMBODIMENTS

The water-soluble paint composition of the present invention comprises an emulsified paint (A) dispersed in an aqueous medium (B). The emulsified paint (A) includes a multifunctional-group monomer. The multifunctional-group monomer at least comprises two or more functional-groups, wherein the multifunctional-group monomer initiates cross-linking during dehydration (baking) process.

According to an embodiment of the present invention, the emulsified paint (A) comprises a water-soluble emulsified polyurethane paint (A1) or an emulsified epoxy resin paint (A2).

The water-soluble emulsified polyurethane paint (A1) at least comprises a monomer selected from a group consisting of a polyalcohol monomer (a) and a isocyanate monomer (b). The polyalcohol monomer (a) has a formula (1) and the isocyanate monomer (b) has a formula (2) as follow:
R₁—(OH)ₙ (1)
R₂—(NCO)ₘ (2)

In formula (1), R₁ is a carbon chain constituted from primary, secondary, tertiary or quaternary carbons, n is an integer selected from a range 2 to 4, —OH group is bonded to any one of the carbons, and oxygen atom or other atom may be bonded between the carbons.

In formula (2), R₂ is a carbon chain constituted from primary, secondary, tertiary or quaternary carbons, m is an integer selected from a range 2 to 4, —NCO group is bonded to any one of the carbons, and oxygen atom or other atom may be bonded between the carbons.

Each polyalcohol monomer (a) at least includes two or more —OH groups. The polyalcohol monomer (a) comprises, for example, polyglycol such as ethylene glycol, diethylene glycol, triethylene glycol, tetraethylene glycol, pentaethylene glycol, hexaethylene glycol, heptaethylene glycol, octaethylene glycol; polypropylene glycol such as propylene glycol, dipropylene glycol, tripropylene glycol, tetrapropylene glycol; and 1,3-propylene glycol, 1,3-butylene glycol, 1,4-butylene glycol, 1,5-pentylene glycol, 1,6-hexylene glycol, 2,2-dimethyl-1,3-propylene glycol, 2-ethyl-2-butyl-1,3-propylene glycol, 2-ethyl-2-isobutyl-1,3-propylene glycol, 2,2,4-trimethyl-1,6-hexylene glycol, 1,2-cyclohexane dimethanol, 1,3-cyclohexane dimethanol, 1,4-cyclohexane dimethanol, 2,2,4,4,-tetramethyl-1,3-cyclobutylene glycol, 4,4′-dialkyl diphenol, 4,4′-methylene diphenol or 4,4′-isoproplene diphenol. Wherein, the polyalcohol monomer (a) includes 2 to 12 carbons in consideration of water solubility property. The polyalcohol monomer (a) may comprise a single polyalcohol monomer or a mixture of two or more polyalcohol monomers.

Each isocyanate monomer (b) at least includes two or more —NCO groups. The isocyanate monomer (b) comprises, for example, polyisocyanate derivatives or a mixture thereof. The polyisocyanate derivatives may be obtained from uramino-formatization, biuret reaction, dimerization (uramino-diketoneization), trimerization (isocyano uratization), addition or carbonyl iminzation of hexamethylene diisocyanate, isophorone diisocyanate, bis(4-isocyanate cyclohexyl)methane, bis(4-isocyanate phenyl)methane, bis(3-chloro-4-isocyanate phenyl)methane, 2,4-methyl phenylene diisocyanate, 2,6-methyl phenylene diisocyanate, tri(4-isocyanate phenyl)methane, 1,2-phenyl dimethyl diisocyanate, 1,4-phenyl dimethyl diisocyanate, 1,2-hydrophenyl dimethyl diisocyanate, 1,4-hydrophenyl dimethyl diisocyanate, tetramethyl phenyl dimethyl diisocyanate, hydrotetramethyl phenyl dimethyl diisocyanate, hexamethylene diisocyanate, norbornane diisocyanate and the like. The isocyanate monomer (b) may comprise a single isocyanate monomer or a mixture of two or more isocyanate monomers. The isocyanate monomer (b) includes 2 to 12 carbons in consideration of water solubility property.

The emulsified epoxy resin paint (A2) at least comprises a monomer selected from a group consisting of an epoxy monomer (c), a polybasic carboxylic acid monomer (d) and an amino group-containing monomer (e). The epoxy monomer (c) has a formula (3), the polybasic carboxylic acid monomer (d) has a formula (4) and the amino group-containing monomer (e) has a formula (5) as follows: 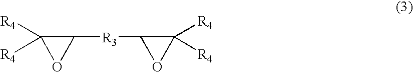
R₅ [symbol] COOH)_{q} (4)

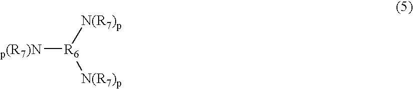

In formula (3), R₃ is a carbon chain constituted from primary, secondary, tertiary or quaternary carbons, and a hetero-atom such as oxygen, nitrogen, silicon, sulfur and the like, may be bonded between the carbons. R₄ is hydrogen or alkyl. R₄ are the same or different, and a hetero-atom such as oxygen, nitrogen, silicon, sulfur and the like, may also be bonded between carbons of R₄.

In formula (4), R₅ is a carbon chain constituted from primary, secondary, tertiary or quaternary carbons, q is an integer selected from a range 2 to 4, each —COOH group is bonded to any one of the carbons, and a hetero-atom such as oxygen, nitrogen, silicon, sulfur and the like, may be bonded between the carbons.

In formula (5), R₆ is a carbon chain constituted from primary, secondary, tertiary or quaternary carbons, —N(R₇)ₚ group is bonded to any one of the carbons, and a hetero-atom such as oxygen, nitrogen, silicon, sulfur and the like, may be bonded between the carbons. Each R₇ is hydrogen or alkyl, all R₇ bonded to nitrogen atom are the same or different, and p is an integer selected from a range 1 to 2.

Each epoxy monomer (c) at least includes two epoxy groups having a formula (6). 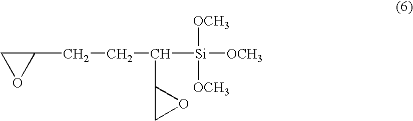
Preferably, the epoxy monomer (c) includes 2 to 12 carbons. The epoxy monomer (c) may comprise a single epoxy monomer or a mixture of two or more epoxy monomers.

Each polybasic carboxylic acid monomer (d) at least includes two or more —COOH groups. The polybasic carboxylic acid monomer (d) comprises, for example, hemimellitic acid, trimellitic acid, trimesic acid, mellophanic acid, pyromellitic acid, phenyl tetracarboxylic acid, phenyl hexacarboxylic acid, cyclopropyl-1,2,3-tricarboxylic acid, cyclopentyl-1,2,3,4-tetracarboxylic acid, ethyl tetracarboxylic acid and the like. The polybasic carboxylic acid can also be anhydrous polybasic carboxylic acid, ether oxychloride, halide and derivatives thereof that can be reacted with glycol to form ether. The polybasic carboxylic acid monomer (d) may comprise a single polybasic carboxylic acid monomer or a mixture of two or more polybasic carboxylic acid monomers. Preferably, the polybasic carboxylic acid monomer (d) includes 2 to 12 carbons.

Each amino group-containing monomer (e) at least includes two or more amino groups. Preferably, the amino group-containing monomer (e) includes 2 to 12 carbons.

The aqueous medium (B) comprises water, a hydrophilic solvent or a mixture thereof. The hydrophilic solvent comprises, for example, methanol, ethanol, 2-propanol and the like; propylene glycol monomethyl ether, ethyl glycol ether, butyl glycol ether and the like; and cyclohexanol. The mixture ratio of water and the hydrophilic solvent is not limited herein.

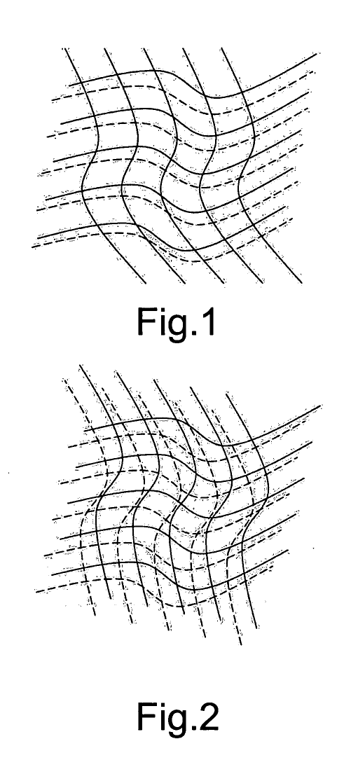

The composition of the water-soluble paint composition according to an embodiment of the present invention is described above. The mechanism of cross-linking reaction is not exactly known, however it is believed that the cross-linking reaction is most likely mechanism of reaction is polymerization. The hydrophilic difunctional-group monomer or multifunctional-group monomer is bonded on the surface of the emulsified paint. A polymerization reaction is initiated during dehydration (baking) process. If the water-soluble paint composition comprises a difunctional-group monomer, the polymerization would lead to the formation of semi-interpenetrating polymer network (SIPN) as shown in FIG. 1. If the water-soluble paint composition comprises a multifunctional-group monomer, the polymerization would lead to the formation of interpenetrating polymer network (IPN) as shown in FIG. 2. Comparing with conventional linear paint, the SIPN paint or the IPN paint of the present invention is capable of improving the mechanical properties of the surface. Thus, by applying the paint of the present invention on the outer surface of the electronic product, the mechanical properties (such as hardness, abrasion resistance, solvent resistance and the like) of the electronic product can be substantially improved.

FIG. 1 and FIG. 2 show the surface structure of the paint applied on a surface of, for example, an article, in that surface structure illustrated by the black lines can be obtained by the water-soluble paint such as the water-soluble polyurethane paint (A1) or the epoxy resin paint (A2) not containing any multifunctional-group monomer, and the smoother surface structure illustrated by the dotted lines can be obtained by the water-soluble polyurethane paint (A1) or the epoxy resin paint (A2) containing the multifunctional-group monomer, which may be due to the presence of the multifunctional-group monomer on the surface. If the water-soluble paint includes a difunctional-group monomer, the surface structure comprises a semi-interpenetrating polymer network (SIPN) as shown in FIG. 1. If the water-soluble paint includes a multifunctional-group monomer (C2), the surface structure comprises an interpenetrating polymer network (IPN) as shown in FIG. 2.

The present invention can also be applied to an emulsified polymer paint having core shell structure. The shell layer of the emulsified polymer paint is first processed to include multifunctional-group so that the multifunctional-group can initiate cross-linking process during dehydration (baking) process to form a highly cross-linked structure on the shell layer.

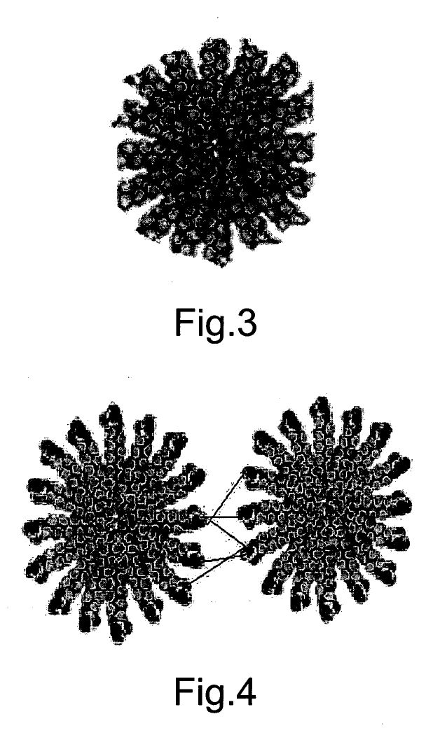

FIG. 3 is a diagram showing a typical core shell emulsified polymer. FIG. 4 is a diagram showing a reaction between multifunctional-groups of a core shell emulsified polymer. As shown in FIG. 3 and FIG. 4, the shell layer is processed to include multifunctional-group so that cross-linking between the multifunctional-group and the composition of the water-soluble paint during the baking process forms a highly cross-linked structure on the shell layer.

In addition, powders obtained by drying the water-soluble paint composition of the invention may be sprayed over a substrate to improve the mechanical properties of the substrate.

Colors or other additives may also be added into the water-soluble paint composition of the present invention, if necessary.

As described above, in the water-soluble paint composition of the present invention, the hydrophilic difunctional-group monomer or multifunctional-group monomer is bonded on the surface of the emulsified paint. Polymerization of the paint composition is initiated during dehydration (baking) process to form a structure having semi-interpenetrating polymer network, interpenetrating polymer network or highly cross-linked structure. Thus, by applying the paint of the present invention on the outer surface of the electronic product, the mechanical properties (such as hardness, abrasion resistance, solvent resistance and the likes) of the electronic product can be effectively improved.

Comparing with conventional hydrophobic paint, the water-soluble paint composition does not harmful to human health because it contains water-soluble solvent. Besides, powders obtained from drying water-soluble paint composition can be sprayed over a substrate to improve the mechanical properties of the substrate.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

1. A water-soluble paint composition, comprising:
an emulsified paint (A), dispersed in an aqueous medium (B), wherein the emulsified paint (A) comprises a multifunctional-group monomer at least comprising two or more functional-groups,
wherein the multifunctional-group monomer initiates cross-linking process during dehydration (baking) process.

2. The water-soluble paint composition according to claim 1, wherein the emulsified paint (A) comprises an emulsified water-soluble polyurethane paint (A1) or an emulsified epoxy resin paint (A2).

3. The water-soluble paint composition according to claim 2, wherein the emulsified water-soluble polyurethane paint (A1) comprises a monomer selected from a group consisting of a polyalcohol monomer (a) and a isocyanate monomer (b),
the polyalcohol monomer (a) has a following formula (1):
R₁—(OH)ₙ (1)
wherein R₁ is a carbon chain constituted from primary, secondary, tertiary or quaternary carbons, n is an integer selected from a range 2 to 4, —OH group is bonded to any one of the carbons, and oxygen atom or other atom can be bonded between the carbons,
the isocyanate monomer (b) has a following formula (2):
R₂—(NCO)ₘ (2)
wherein R₂ is a carbon chain constituted from primary, secondary, tertiary or quaternary carbons, m is an integer of from 2 to 4, —NCO group is bonded to any one of the carbons, and oxygen atom or other atom can be bonded between the carbons.

4. The composition according to claim 3, wherein the polyalcohol monomer (a) includes 2 to 12 carbons.

5. The water-soluble paint composition according to claim 3, wherein the isocyanate monomer (b) includes 2 to 12 carbons.

6. The water-soluble paint composition according to claim 2, wherein the emulsified epoxy resin paint (A2) comprises a monomer selected from a group consisting of an epoxy monomer (c), a polybasic carboxylic acid monomer (d) and a amino group-containing monomer (e),
the epoxy monomer (c) has a following formula (3): 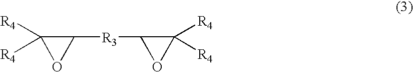
wherein R₃ is a carbon chain constituted from primary, secondary, tertiary or quaternary carbons, and hetero-atom can be bonded between the carbons; each R₄ is hydrogen or alkyl, R₄ can be the same or different, and a hetero-atom can be bonded between carbons of R₄,
the polybasic carboxylic acid monomer (d) has a following formula (4):
R₅ [symbol] COOH)_{q} (4)
wherein R₅ is a carbon chain constituted from primary, secondary, tertiary or quaternary carbons, q is an integer selected from a range 2 to 4, each —COOH group is bonded to any one of the carbons, and a hetero-atom can be bonded between the carbons,
the amino group-containing monomer (e) has a following formula (5): 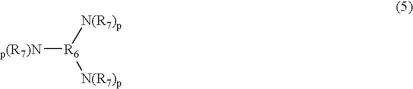
wherein R₆ is a carbon chain constituted from primary, secondary, tertiary or quaternary carbons, —N(R₇)ₚ group is bonded to any one of the carbons, a hetero-atom can be bonded between the carbons; each R₇ is hydrogen or alkyl, R₇ bonded to nitrogen atom can be same or different; and p is an integer selected from a range 1 to 2.

7. The water-soluble paint composition according to claim 6, wherein the hetero-atom comprises oxygen, nitrogen, silicon or sulfur.

8. The water-soluble paint composition according to claim 6, wherein the epoxy monomer (c) includes 2 to 12 carbons.

9. The water-soluble paint composition according to claim 6, wherein the polybasic carboxylic acid monomer (d) includes 2 to 12 carbons.

10. The water-soluble paint composition according to claim 6, wherein the amino group-containing monomer (e) includes 2 to 12 carbons.

11. A paint comprising powders obtained from drying a water-soluble paint composition comprising an emulsified paint (A) dispersed in an aqueous medium (B), wherein the emulsified paint (A) comprises a multifunctional-group monomer at least comprising two or more functional-groups, wherein the multifunctional-group monomer initiates cross-linking process after drying.
